(19) United States
(12) Patent Application Publication
(10) Pub. No.: US 2013/0223085 A1
(43) Pub. Date: Aug. 29, 2013

(54) All-around LED light

(71) Applicant: I-Sin Peng, Taichung City (TW)

(72) Inventor: I-Sin Peng, Taichung City (TW)

(21) Appl. No.: 12/000,192

(22) Filed: Dec. 10, 2007

(51) Int. Cl. F21V 1/00; F21S 2/00

(52) U.S. Cl. CPC F21V 1/00
USPC 362/477

(57) ABSTRACT

An all-around LED light allows fast assembly and disassembly, high luminance, convenient replacement, and use safety includes multiple concave panels each related to a parabolic mirror made in a proper curvature by compromising a relative location of a light emitting diode adapted; light streams from the LED are emitted upward and reflected to scatter horizontally; multiple units comprised of the LED and the concave panel being arranged in a circle to form a all-around light radiating light streams to its surroundings; a structure of the all-around LED light is comprised of two semi-products located by having two bolting pillars from a bolting holder to penetrate through two secondary bolting holes disposed on a reflective mask and clicked by multiple circular ribs respectively from a lampshade and a base in a mutual containment status; one semi-product is comprised of a locating disk with its bottom resting on a locating holder and an upper end of the bolting holder, both bolting pillars on the base penetrate upward into both first bolting holes on the locating disk, and two locating screws penetrate downward through both locating holes to be fastened in the locating holder; another semi-product has the reflective mask to be inserted into the lampshade for an inverted taper and a fixation holder to hold against each other, a direction holder is inserted into a direction groove, a fixation screw is fastened into the fixation holder disposed at a lower end of the inverted taper, and a face cover covers upon and is clicked to a top of the lampshade.

### BACKGROUND OF THE INVENTION

(a) Field of the Invention

The present invention is related to an all-around LED light, and more particularly to a light emission unit comprised of multiple light emitting diodes arranged in a circular fashion and a concave panel, the concave panel being related to a parabolic mirror made in a proper curvature according to relative location of a single LED and light streams being reflected by the parabolic mirror to outward radiate and scatter.

(b) Description of the Prior Art

All-around lights generally available in the market emit light by heating a filament in a light bulb to generate thermal energy far greater than optical energy produced. Accordingly, temperature of the peripheral to the all-around light will become extremely high to warrant protection from a container with high heat resistant property to avoid burning from human contact or damaging surface glass. The light bulb containing the filament is usually secured in place by a thread disposed at the lower end of the light bulb and the light bulb must be replaced with a new one once the filament gets thinner and eventually burnt out. The prior art is found with the following defects:

1. The all-around light of the prior art works with the light bulb as the primary light emitting object by converting electric energy to present in the forms of light and heat and only up to 5% of energy converted are capable of radiating the light in a spherical form while the rest of the energy are converted into useless thermal energy resulting in short service life, heat generation, excessively power consumption, and being vulnerable to break.

2. Replacing the bulb only can be done when the temperature to the peripheral of the bulb cools down to ambient temperature or an aid of certain object or tool must be used resulting in waste of time and increased difficulty in replacement.

3. There is usually only one light bulb mounted in the all-around light of the prior art; once the light bulb is damaged or fails, the safety is immediately compromised when the ship is steering during night or misty hours.

### SUMMARY OF THE INVENTION

The primary purpose of an all-around LED light of the present invention is to provide an LED bulb to correct those defects found with the prior art.

To achieve the purpose, a locating disk is disposed with multiple light emitting diodes arranged in a circular form with a locating hole and a first bolting hole at the center that correspond to a screw hole on a locating base and a bolt from a bolting base. A reflection mask related to a reflective wall is comprised of multiple concave panels having a same curvature abutted to one another, and a flat board is connected to a lower end of the reflection mask for both of the reflective mask and the flat plate to take a shape of a bowl. A fixation holder is disposed at a center of the flat plate and a directional holder extends from a side of the fixation holder; and a second bolting hole penetrate through in relation to where a bolting pillar on the bolting holder is located. Both of the second bolting hole and the bolting pillar by locating to each other facilitates each LED to adapt to a concave panel for the LED to radiate light streams to its surroundings. LED for featuring power saving, long service life, and free of generating heat provides much higher value of operation benefits than a light bulb.

A bottom of the locating disk rests on the locating holder and upper ends of two bolting holders to indicate a suspended status. A bolt from a bolting holder disposed on a base of the all-around LED light penetrates upward into the first bolting hole of the locating disk, and two locating screws downward penetrate through respectively locating hole to fasten in the locating holder to constitute a semi-product of a structure of the present invention. The reflective mask is contained in a lampshade to form an inverted taper holding against the fixation holder with the directional hold locked into a directional groove. A fixation screw penetrates an lower end of the inverted taper to fasten into the fixation holder; and a face cover covers up and clicks on the lampshade to constitute another semi-product of the structure of the present invention. Both semi-products are located by having the bolting pillar on the bolting holder to penetrate through the second bolting hole on the reflective mask and clicked in position by the lampshade and multiple circular ribs disposed on the base in an intrigue relationship of mutual containment. Whereas the LED in operation will not generate heat, it takes only to disengage the upper semi-product from those circular ribs disposed between a locating board and the upper semi-product and to loosen up those locating screws of the lower semi-product upon replacing the locating disk to save time and achieve convenient replacement.

A basic light emitting unit disposed on the locating disk is comprised of an LED and its respective concave panel from the reflective mask. By taking advantage of the concave panel that indicates a parabolic mirror, which is made with a proper curvature by compromising the location of the LED. Reflected light streams scatter outwardly, and multiple light emitting units arranged in a circular form to radiate light streams to their surroundings. Whereas each LED features high luminance, any single LED when damaged or fails will not affect normal operation of other LEDs to continuously emit light streams in a luminance much higher than that of the regular bulb to provide the function of luminance supplementation while maintaining a all-around light with uninterrupted efficacy.

Emitting a single color light is one of the features of the LED and the LED is capable of emitting light streams in a color as designed without relying upon changing the color of a casing. Multiple locating disks with each emitting a selected color different from that emitted from other locating disk for alternating among colors depending on the sailing situation to achieve practical economic benefits.

### BRIEF DESCRIPTION OF THE DRAWINGS

FIG. 1 is an exploded view showing an exploded view of a structure of a all-around light of the present invention.

FIG. 1-A is a perspective view showing a parabolic mask in the structure of the present invention.

FIG. 2 is a perspective view showing the structure of the all-around light of the present invention.

FIG. 3 is a sectional view showing a preferred embodiment of the structure of the present invention.

FIG. 4 is a perspective view showing the structure of the present invention.

FIG. 5 is a bird's view of the structure of the preferred embodiment of the present invention.

### DETAILED DESCRIPTION OF THE PREFERRED EMBODIMENTS

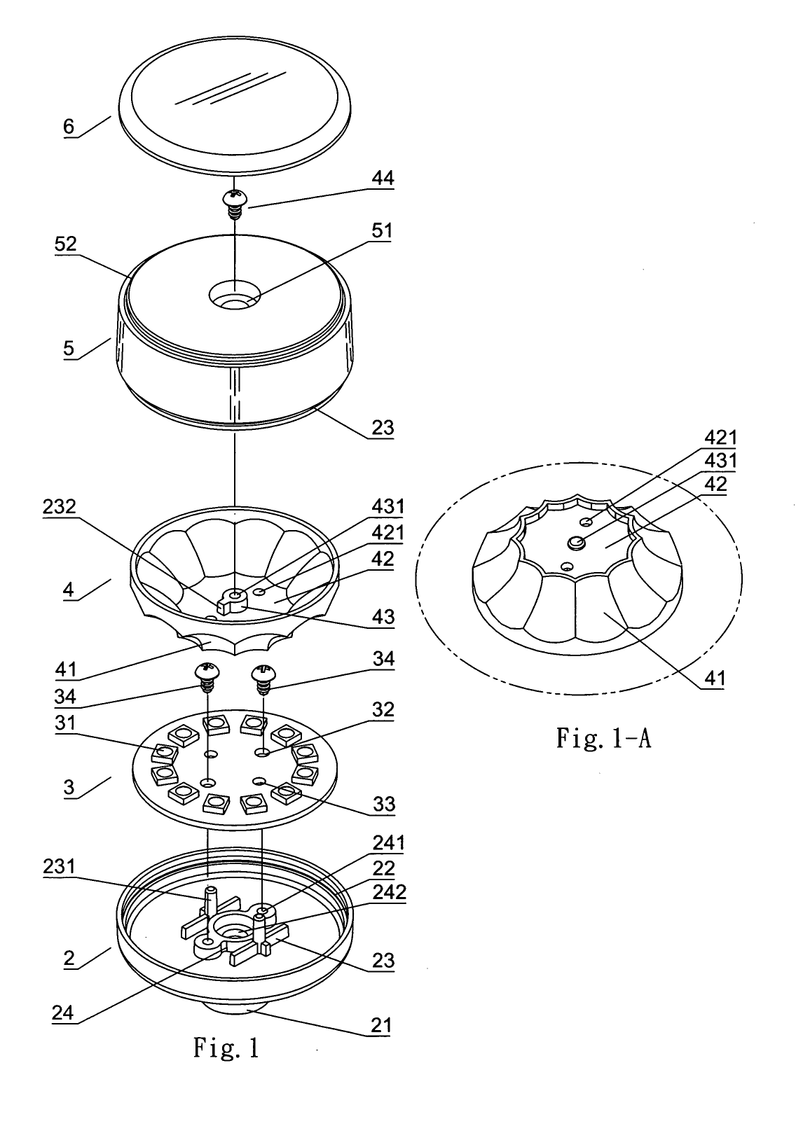

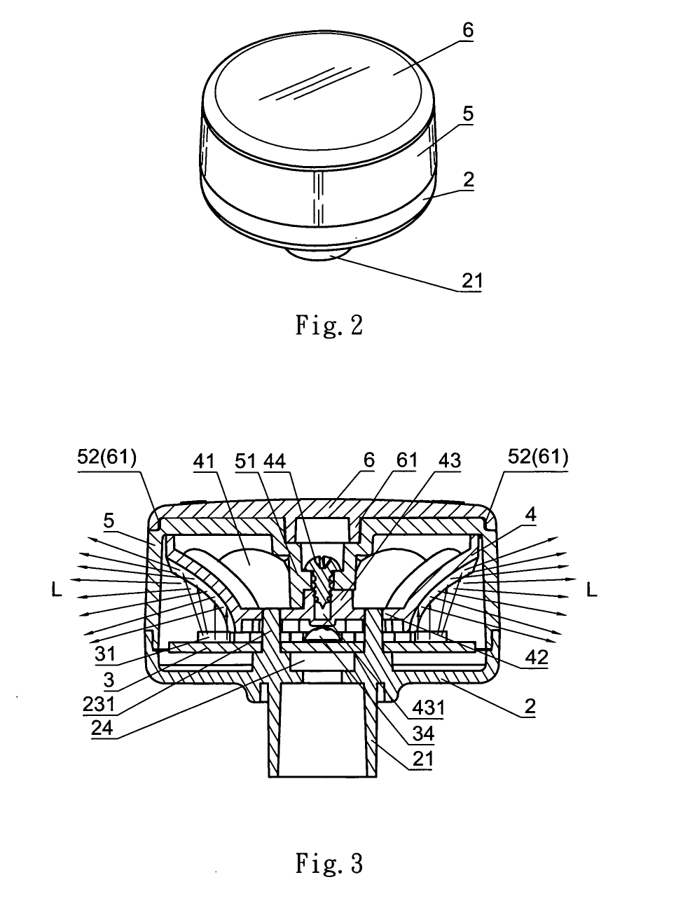

Referring to FIGS. 1, 1-A, and 2, an all-around LED light is essentially comprised of a base 2, a locating disk 2, a reflective mask 4, a lampshade 5, and a face cover 6 overlapped on one another in series. A first circular rib 22 is disposed on an inner edge of a side of the base 2; a hollow connection rod 21 is connected to where below the base 2; a locating holder 24 is disposed at a center on the base 2; two lower screw holes 241 are respectively disposed at two ends of the locating holder 24; a through hole 242 penetrating the hollow connection rod 21 is disposed at the center of the base 2; and two bolting holders 23 are disposed on two sides of the through hole 242; two bolting pillars 231 extend upward from a mid section of the bolting holder 23 in opposite to each other and in a same proper height; and both of the locating holder 24 and the bolting holder 23 are at a same level of height. Multiple light emitting diodes 31 arranged in a circular form are disposed on the locating disk 3; two locating holes 32 and two first bolting holes 33 are disposed at a center of the locating disk 3 at where corresponding to both screw holes 241 disposed to the locating holder 24 and two bolting pillars 231 disposed on the bolting holder 23. The reflective mask 4 is comprised of multiple concave panels 41 abutted to one another with each of same proper curvature and has its lower end connected to a flat board 42 to take a shape of a bowl. A fixation holder 43 is disposed on a center of the flat board 42; an upper screw hole 431 is disposed at a center of the fixation holder 43; a directional holder 432 extends from one side of the fixation holder 43; and two second bolting holes 421 penetrate through the flat board 42 are disposed at where both bolting pillars 231 of the bolting holder 23 are located. The lampshade 5 is related to a hollow cylinder with an opening facing downward; a lower circular rib 53 clicked by the base 2 is provided to an outer circumference at an lower end of the lampshade 5; an upper circular rib 51 clicked to the face cover 6 is disposed to an outer circumference at an upper end of the lampshade 5; an inverted taper 51 downward extends and reduces in gradation from a center of the top of the lampshade; and a directional groove 511 to merely receive insertion by the directional holder 432 of the fixation holder 43 to merely insert into is provided at a lower end of the tapered object 51. The face cover 6 is disposed with a second circular rib 61 on a side inner edge; and an insertion circle 62 is disposed in a middle of a lower edge of the face cover 6 to merely insert onto a top layer of the inverted taper 51 of the lampshade 5.

Now referring to FIGS. 1 and 3, the base 2, the locating disk 3, the reflective mask 4, the lampshade 5, and the face cover 6 are overlapped on one another in sequence from top. The bottom of the locating disk rests on the locating holder 24 and the upper ends of both bolting holders 23 to indicate a suspended status; each bolting pillar 231 of the bolting holder 23 on the base 2 penetrates upward to insert to top into the first bolting hole 33 on the locating disk 3; two locating screws 34 penetrates downward through the locating holes 32 to fasten in the locating holder 24 to firmly secure in place for constituting a semi-product. The reflective mask 4 is inserted into the lampshade 5 for both of the inverted taper 51 and the fixation holder 43 to hold against each other; the directional holder 423 is inserted into the direction groove 511; the fixation holder 43 is fastened by a fixation screw 44 penetrating through a lower end of the inverted taper 51; the face cover covers up and is clicked to where above the lampshade 5 for providing attractive appearance to constitute another semi-product of the structure. Both semi-products are located by having both bolting pillars 231 on the bolting holder 23 to penetrate and insert into both second bolting holes 33 and then clicked by both circular ribs 22, 53 respectively disposed on the base 2 and the lampshade 5 to form a relationship of mutual containment for providing easy fixation and convenient assembly and disassembly to facilitate service job in replacing the locating disk 3.

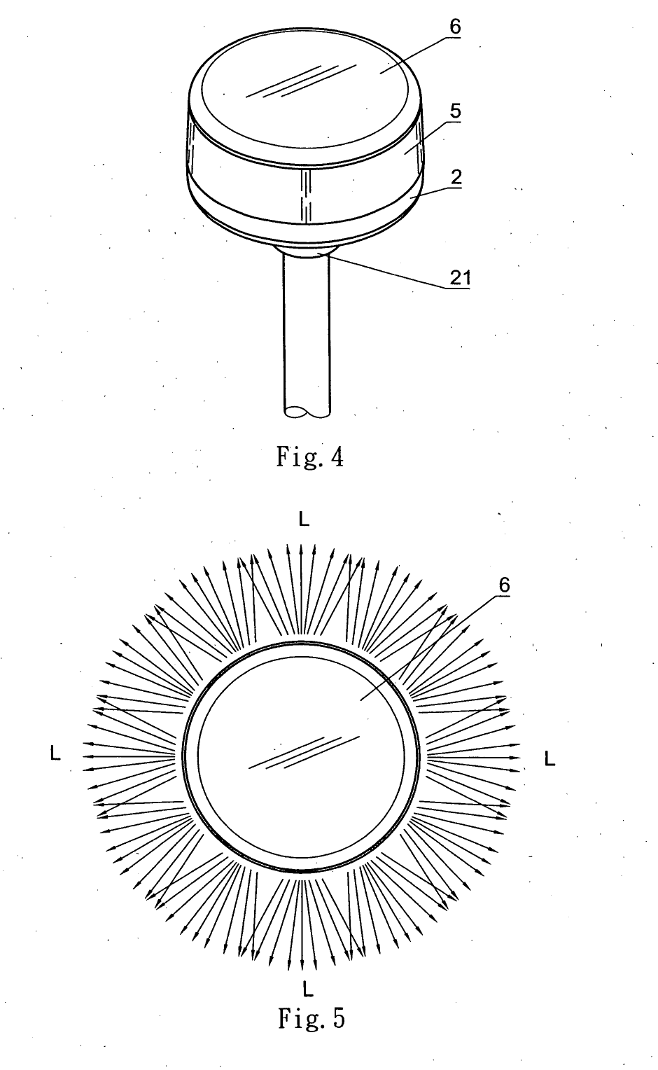

As illustrated in FIGS. 3 through 5, each LED 31 and each concave panel 41 disposed on the side of the reflective mask 4 constitute a basic light emitting unit. Whereas the concave panel 41 is related to a parabolic mirror, it is made with a proper curvature by compromising the location where the LED 31 is provided. Accordingly, light streams reflected by the parabolic mirror externally scatter and multiple light emitting units arranged in a circle radiate light streams to their surroundings. As the LED features high reliability and high luminance, the use of the all-around LED light significantly upgrade sailing safety. In case of any single LED is damaged or fails, it will not affect normal operation of the rest of the LEDs 31 to continuously emit light. Furthermore, luminance of the light emitted by LED is much higher than that by a regular light bulb to provide luminance supplementation for the all-around LED light to achieve the same function as that provided by the regular light bulb.

Emitting a single color of light is one of the features of the LED and the color of the light varies depending on frequency and wave length. The color of the light emitted from the LED therefore can be selected as required for the present invention to allow change of light color by direct replacement of the locating disk for providing general economic benefits.

The present invention by having arranged multiple light emitting diodes 31 in a circular form and by taking advantage of the parabolic surface of the reflective mask 5 to change routes of light emission for scattering light emission to the surroundings in substituting the conventional light bulb while having its composition elements to form mutual containment by lateral locating inside and longitudinal clicking outside provides benefits of convenient replacement and higher use safety; therefore the application for a utility patent is duly filed accordingly.

I claim:

1. An all-around LED light related to a light source mounted to a bow of a sea vessel comprising:
a base having disposed on its side inner edge a first circular rib, its lower end connected to a hollow connection rod, its top disposed with a locating holder, two screw holes being provided to both ends of the locating holder, a through hole being disposed at a center of the locating holder to penetrate through the hollow connection rod, two bolting holders being disposed on both sides of the base, and a bolting pillar extending upward from a middle section of each bolting holder;
a locating disk provided thereon multiple light emitting diodes arranged in a circle, a locating hole and two first bolting holes corresponding to the screw hole on the locating holder and both bolting pillars on the bolting holder locating holder being disposed at a center of the locating disk;
a reflective mask related to a wall comprised of multiple concave panels abutted to one another with each having the same proper curvature, a lower end of the reflective mask being connected to a flat board to take a shape of a bowl, a fixation holder being disposed at a center of the flat board, a screw hole being provided at a center of the fixation holder, a direction holder extending from a side of the fixation holder, and two secondary bolting holes penetrating through the flat board at where corresponding to the location of bolt bolting pillars on the bolting holder;
a lampshade related to a hollow cylinder having an opening facing downward, a lower circular rib clicked to the base being disposed on an outer circumference at the lower end of the lampshade, an upper circular rib clicked to a face cover being disposed on an outer circumference at the upper end of the lampshade, an inverted taper extending downward and reducing from a center of the lampshade in gradation, and a directional groove being disposed at a lower end of the inverted taper to receive insertion by the directional holder from the fixation holder; and
a face cover having disposed at its inner edge a second circular rib and an insertion groove being disposed in the middle of a lower end of the face cover to be merely inserted by a top layer of the inverted taper characterized in that each LED and each concave panel forming a basic light emitting unit; light streams being emitted upward from the LED before being reflected to scatter horizontally; multiple basic light emitting unit being arranged in a circle to form a all-around light to emit light streams to its surroundings, a structure of the all-around light being located by having both bolting pillars to penetrate their respective secondary bolting holes and clicked by those circular ribs respectively disposed on the lampshade and the base to constitute an intrigue relationship of mutual containment in achieving practical benefits of providing convenient replacement of light source and higher use safety.

2. The all-around LED light as claimed in claim 1, wherein both of the base and the hollow connection rod are locked to each other or made an integral part.

3. The all-around LED light as claimed in claim 1, wherein the appearance of the structure is designed in a polygonal or circular form.

4. The all-around LED light as claimed in claim 1, wherein the lampshade is made of a transparent or a colored material depending on a color of the light emitted from the LED.

5. The all-around LED light as claimed in claim 1, wherein a color of the light emitted from the LED is selected as required.
